(19) United States
(12) Patent Application Publication
(10) Pub. No.: US 2025/0063968 A1
(43) Pub. Date: Feb. 27, 2025

(54) STRIP TILLAGE IMPLEMENT AND RELATED SYSTEMS AND METHODS

(71) Applicant: CNH Industrial America LLC, New Holland, PA (US)

(72) Inventors: Austin Joseph Lewandowski, Congerville, IL (US); William E. Preller, Congerville, IL (US)

(21) Appl. No.: 18/810,692

(22) Filed: Aug. 21, 2024

Related U.S. Application Data
(60) Provisional application No. 63/578,756, filed on Aug. 25, 2023.

(51) Int. Cl. A01B 33/12; A01B 49/02

(52) U.S. Cl. CPC A01B 33/12; A01B 49/027

(57) ABSTRACT

A strip tillage implement includes a toolbar assembly having a central toolbar section and a wing toolbar section pivotably coupled together. The central toolbar section includes a central toolbar, a first central frame member, and a second central frame member, where the first central frame member is spaced apart from the central toolbar along a fore-aft direction, the second central frame member is spaced apart from the central toolbar along the fore-aft direction and a vertical direction, and the second central frame member is spaced apart from the first central frame member in the vertical direction. The wing toolbar section includes a wing toolbar and a wing frame member, where the wing frame member is spaced apart from the wing toolbar along both the fore-aft direction and the vertical direction.

### CROSS-REFERENCE TO RELATED APPLICATIONS

The present application is based upon and claims the right of priority to U.S. Provisional Patent Application No. 63/578,756, filed Aug. 25, 2023, the disclosure of which is hereby incorporated by reference herein in its entirety for all purposes.

### FIELD OF THE INVENTION

The present subject matter relates generally to agricultural implements, such as strip tillage implements and, more particularly, to a strip tillage implement with an improved frame and related system and method for use with such strip tillage implement.

### BACKGROUND OF THE INVENTION

It is well known that, to attain the best agricultural performance from a field, a farmer must cultivate the soil, such as through a tillage operation. Tillage implements typically include one or more ground engaging tools configured to engage the soil as the implement is moved across the field. Such ground engaging tool(s) loosen and/or otherwise agitate the soil to prepare the field for subsequent agricultural operations, such as planting operations. Strip tillage implements, unlike traditional tillage implements, include row units having one or more of such ground-engaging tools, where the row units only work narrow strips of the field in which subsequent operations (e.g., planting) will occur, instead of working the entire field along the swath of the implement. Currently, the increased complexity and weight of the strip tillage implements makes it difficult to fold strip tillage implements, which limits the overall working width of strip tillage implements.

Accordingly, a strip tillage implement with an improved frame, and an associated system and method for use with such improved strip tillage implement, would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a strip tillage implement. More particularly, the strip tillage implement may include a toolbar assembly having a central toolbar section and a wing toolbar section pivotably coupled to the central toolbar section such that the wing toolbar section is pivotable relative to the central toolbar section between a working position and a transport position. The central toolbar section may include a central toolbar, a first central frame member, and a second central frame member coupled together to form a central truss structure, where the first central frame member may be spaced apart from the central toolbar along a fore-aft direction, the second central frame member may be spaced apart from the central toolbar along the fore-aft direction and a vertical direction, and the second central frame member may be spaced apart from the first central frame member in the vertical direction. The wing toolbar section may include a wing toolbar and a wing frame member coupled together to form a wing truss structure, where the wing frame member may be spaced apart from the wing toolbar along both the fore-aft direction and the vertical direction. Additionally, the strip tillage implement may include a plurality of strip tillage row units supported on the central toolbar and the wing toolbar.

In another aspect, the present subject matter is directed to a strip tillage implement. More particularly, the strip tillage implement may include a toolbar assembly having a central toolbar section, an inner-wing toolbar section, and an outer-wing toolbar section. The inner-wing toolbar section may be pivotably coupled to the central toolbar section such that the inner-wing toolbar section is pivotable relative to the central toolbar section between an inner-wing working position and an inner-wing transport position. The inner-wing toolbar section may particularly include an inner-wing toolbar and an inner-wing frame member which may be coupled together to form an inner-wing truss structure, and where the inner-wing frame member may be spaced apart from the inner-wing toolbar along both a fore-aft direction and a vertical direction. Similarly, the outer-wing toolbar section may particularly include an outer-wing toolbar and an outer-wing frame member coupled together to form an outer-wing truss structure, where the outer-wing frame member may be spaced apart from the outer-wing toolbar along both the fore-aft direction and the vertical direction. The toolbar assembly may additionally include a tilted pivot joint which may pivotably couple the outer-wing toolbar section to the inner-wing toolbar section such that the outer-wing toolbar section is pivotable about a tilted pivot axis defined by the tilted pivot joint relative to the inner-wing toolbar section between an outer-wing working position and an outer-wing transport position. In particular, the tilted pivot axis may extend at a non-zero angle relative to both the vertical direction and the fore-aft direction. Additionally, the strip tillage implement may include a plurality of strip tillage row units supported on the central toolbar section, the inner-wing toolbar, and the outer-wing toolbar.

In further aspect, the present subject matter is directed to a method for operating a strip-till implement. In particular instances, the strip-till implement may include a central toolbar section, an inner-wing toolbar section, and an outer-wing toolbar section. The inner-wing toolbar section may be pivotably coupled to the central toolbar section such that the inner-wing toolbar section is pivotable between an inner-wing transport position and an inner-wing working position. Similarly, the outer-wing toolbar section may be pivotably coupled to the inner-wing toolbar section such that the outer-wing toolbar section is pivotable relative to the inner-wing toolbar section between an outer-wing transport position and an outer-wing working position. Each of the inner-wing toolbar section and the outer-wing toolbar section may have a wing toolbar and a wing frame member coupled together to form a respective wing truss structure, where the wing frame member may be spaced apart from the wing toolbar along both a fore-aft direction and a vertical direction, and where the wing toolbar of each of the inner-wing toolbar section and the outer-wing toolbar section may support a plurality of strip-till row units. Specifically, the method may include receiving, with a computing system, an input indicative of a request to perform a narrow-working operation with the strip-till implement in a field. Moreover, the method may include controlling, with the computing system, one or more actuators of the strip-till implement to move the inner-wing toolbar section into the inner-wing working position and to move the outer-wing toolbar section into the outer-wing transport position in response to receiving the input indicative of the request to perform the narrow-working operation. Additionally, the method may include performing the narrow-working operation with the strip-till implement as the strip-till implement moves across the field while the inner-wing toolbar section is in the inner-wing working position and the outer-wing toolbar section is in the outer-wing transport position such that the plurality of strip-till row units on the inner-wing toolbar section engages the field without the plurality of strip-till row units on the outer-wing toolbar section engaging the field.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural implement in accordance with aspects of the present subject matter;

FIG. 2 illustrates a side view of one embodiment of a row unit suitable for use with the implement shown in FIG. 1 in accordance with aspects of the present subject matter;

FIG. 3 illustrates another perspective view of the agricultural implement shown in FIG. 1 with the row units removed in accordance with aspects of the present subject matter, particularly illustrating additional wing toolbar sections attached to the agricultural implement;

FIG. 4 illustrates a section view of the agricultural implement shown in FIG. 3 in accordance with aspects of the present subject matter, taken with reference to section line 4-4′ in FIG. 3;

FIG. 5 illustrates a partial, side view of the agricultural implement shown in FIGS. 3-4 in accordance with aspects of the present subject matter, particularly illustrating one of the wing toolbar sections;

FIG. 6 illustrates a partial, top-down view of the agricultural implement shown in FIGS. 3-5 in accordance with aspects of the present subject matter, particularly illustrating the implement in a working position;

FIG. 7 illustrates a partial, front view of the agricultural implement shown in FIGS. 3-6 in accordance with aspects of the present subject matter, particularly illustrating the implement in a narrow-working position; and

FIG. 8 illustrates a illustrates a partial, top-down view of the agricultural implement shown in FIGS. 3-7 in accordance with aspects of the present subject matter, particularly illustrating the implement in a transport position.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a strip-tillage implement. Specifically, in several embodiments, the strip-tillage implement may include a central toolbar section and at least one wing toolbar section. In some instances, the central toolbar section is formed from three main structural members including a central toolbar, a first central frame member, and a second central frame member coupled together to form a central truss structure. Particularly, the first central frame member is spaced apart from the central toolbar along a fore-aft direction, the second central frame member is spaced apart from the central toolbar along the fore-aft direction and a vertical direction, the second central frame member is spaced apart from the first central frame member in the vertical direction. In an advantageous manner, each of the at least one wing toolbar section may be formed of two main structural members including a wing toolbar and a wing frame member coupled together in an offset configuration to form a wing truss structure. More particularly, the wing frame member is spaced apart from the wing toolbar along both the fore-aft direction and the vertical direction. Due to the offset configuration of the wing toolbar sections, the wing toolbar sections may be particularly strong against both loads applied along the fore-aft direction and vertical loads, and allows for some nesting with the central toolbar section when folding into the transport position which reduces vertical transport height of the implement.

Moreover, an inner one of the wing toolbar sections may be pivotably coupled to an outer end of the central frame member such that the inner-most wing toolbar section is pivotable relative to the central frame member between a working position and a transport position. Similarly, in some instances, an outer one of the wing toolbar sections may be pivotably coupled to an outer end of the inner-wing toolbar section by a tilted pivot joint such that the outer-wing toolbar section is pivotable relative to the inner-wing toolbar section about a tilted pivot axis between a respective working position and a transport position. The tilted pivot axis particularly extends at a non-zero angle relative to both the vertical direction and the fore-aft direction. Due to the tilted pivot axis, the outer-wing toolbar section may pivot between the working and transport positions, while allowing the inner-wing toolbar section to remain in its respective working position, which allows for greater flexibility in working width of the strip tillage implement.

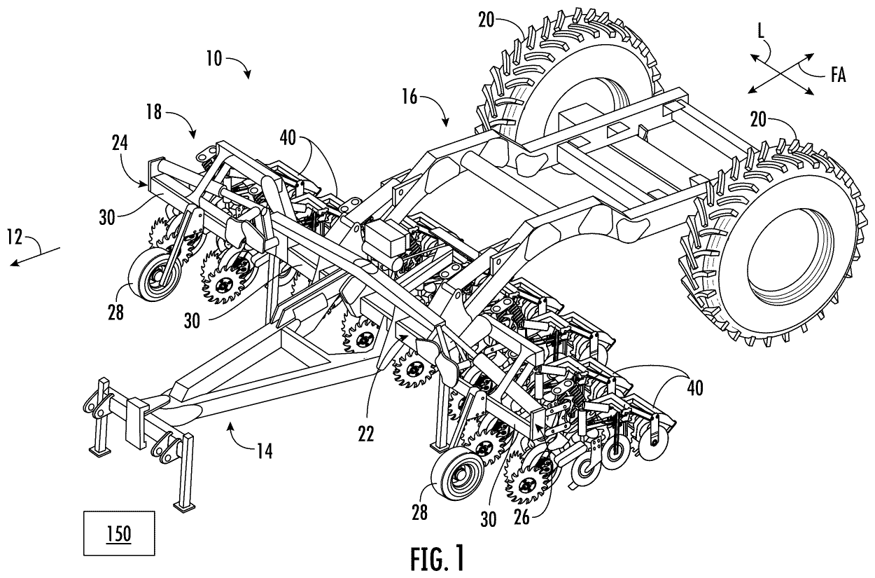

Referring now to the drawings, FIG. 1 illustrates a perspective view of one embodiment of an agricultural implement 10 in accordance with aspects of the present subject matter. In general, the implement 10 may be configured to be towed across a field in a forward direction of travel (e.g., as indicated by arrow 12 in FIG. 1) by a work vehicle (e.g., an agricultural tractor). As shown, the implement 10 is configured as a strip tillage implement. However, in other embodiments, the implement 10 may be configured as any other suitable type of implement, such as a seed-planting implement, a fertilizer-dispensing implement, and/or the like.

As shown in FIG. 1, the implement 10 includes a towbar assembly 14, a chassis assembly 16, and a toolbar assembly 18. As is generally understood, the towbar assembly 14 may be configured to allow the implement 10 to be coupled to a tow vehicle (e.g., a tractor) for towing the implement 10 along a field during the performance of a strip-tillage operation. For instance, the towbar assembly 14 may incorporate a hitch or other suitable coupling for connecting the implement 10 to a tow vehicle. In one embodiment, the chassis assembly 16 may be configured to support one or more storage tanks (not shown). For instance, the storage tank(s) may correspond to a fertilizer tank or any other suitable type of storage tank configured to store an agricultural material. Additionally, the chassis assembly 16 may be coupled to one or more pairs of chassis support wheels 20. For example, as shown in FIG. 1, a pair of support wheels 20 are coupled to the aft end of the chassis assembly 16 to support the implement 10 relative to the ground.

It should be appreciated that, in the illustrated embodiment, the chassis assembly 16 is positioned at the aft end of the implement 10 such that the toolbar assembly 18 is disposed between the towbar assembly 14 and the chassis assembly 16 along the fore-aft direction of the implement 10 (as indicated by arrow FA in FIG. 1). For instance, as shown in FIG. 1, toolbar assembly 18 is pivotably coupled at its forward end to the towbar assembly 14 and at its aft end to the chassis assembly 16. Alternatively, the chassis assembly 16 may be positioned between the towbar assembly 14 and the toolbar assembly 18 in the fore-aft direction FA of the implement 10 (the fore-aft direction FA being generally parallel to the direction of travel 12) such that the toolbar assembly 18 is disposed at the aft end of the implement 10. In such an embodiment, the forward end of the toolbar assembly 18 may be coupled to the aft end of the chassis assembly 16 (e.g., via connecting frame).

In several embodiments, the toolbar assembly 18 may be configured as a winged toolbar assembly. Specifically, as shown in FIG. 1, the toolbar assembly 18 includes a central toolbar section 22 and one or more wing toolbar sections coupled to and extending laterally (e.g., in the lateral direction L) from central toolbar section 22 (e.g., a first wing toolbar section 24 coupled to one lateral end of the central toolbar section 22 and a second wing toolbar section 26 coupled to the opposed lateral end of the central toolbar section 22). Additionally, as shown in FIG. 1, a wing support wheel 28 may be coupled to each wing toolbar section 24, 26 (e.g., at the front of each wing toolbar section 24, 26) to support the toolbar section 24, 26 relative to the ground. In one embodiment, the wing support wheels 28 may be configured to function as gauge wheels for the wing toolbar sections 24, 26.

As is generally understood, each of the various toolbar sections 22, 24, 26 may include one or more laterally extending toolbars 30 configured to support a plurality of row units 40. For instance, in one embodiment, each row unit 40 may be coupled to its respective toolbar 30 via a four-bar linkage. In the illustrated embodiment, the row units 40 are configured as strip tillage units. As such, each row unit 40 may include one or more ground-engaging tools for working the soil in narrow strips extending in the forward direction of travel 12 of implement 10. For instance, in one embodiment, each row unit 40 may include one or more row cleaner discs, coulter discs, shanks or knives, finishing or conditioning units, and/or the like for tilling narrow strips of soil during the performance of a strip tillage operation. Additionally, each row unit 40 may also incorporate one or more components for supplying agricultural materials to the soil, such as injectors or tubes for directing agricultural material (e.g., fertilizer) supplied from a storage tank supported on the chassis assembly 16 (or from any other source) into the worked soil.

Additionally, in some embodiments, a computing system 150 may be provided in communication with one or more components of the implement 10 and/or one or more components of a work vehicle for towing the implement 10. The computing system 150 may correspond to any suitable processor-based device(s), such as a computing device or any combination of computing devices. Thus, the computing system 150 may generally include one or more processor(s) and associated memory devices configured to perform a variety of computer-implemented functions (e.g., performing the methods, steps, algorithms, calculations, and the like disclosed herein). It should be appreciated that the computing system 150 may correspond to an existing controller for the implement 10 or the towing vehicle or may correspond to a separate processing device. For instance, in one embodiment, the computing system 150 may form all or part of a separate plug-in module that may be installed in operative association with the implement 10 or the towing vehicle to allow for the disclosed method to be implemented without requiring additional software to be uploaded onto existing control devices of the implement 10 or the towing vehicle.

In some instances, the computing system 150 may be in communication with one or more user interfaces (not shown) which allows the computing system 150 to receive one or more inputs from the user interface(s) and/or to control the operation of the user interface(s). The user interface(s) may include, without limitation, any combination of input and/or output devices that allow an operator to provide operator inputs to the computing system 150 and/or that allow the computing system 150 to provide feedback to the operator, such as a keyboard, keypad, pointing device, buttons, knobs, touch sensitive screen, mobile device, audio input device, audio output device, and/or the like. As will be described below in greater detail, the computing system 150 may be configured to control the operation of one or more of the actuators of the implement 10 to allow for different operating configurations of the implement 10, such as in response to inputs from the user interface(s).

It should be appreciated that the configuration of the implement 10 described above and shown in FIG. 1 is provided only to place the present subject matter in an exemplary field of use. Thus, it should be appreciated that the present subject matter may be readily adaptable to any manner of implement configuration.

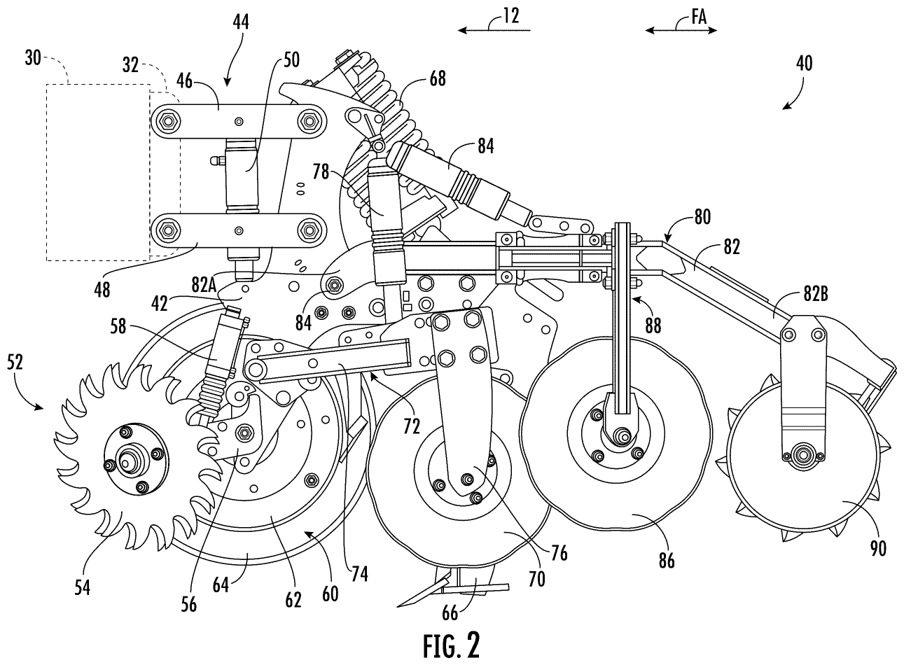

Referring now to FIG. 2, a side view of one embodiment of a row unit 40 suitable for use with the implement 10 shown in FIG. 1 is illustrated in accordance with aspects of the present subject matter. As shown, the row unit 40 includes a main frame or backbone 42 (referred to herein as simply the “frame 42” of the row unit 40) configured to be adjustably coupled to a toolbar (e.g., toolbar 30 and associated mounting bracket(s) 32) of the implement 10 via a linkage assembly 44. For example, in one embodiment, the frame 42 may be coupled to the toolbar 30 via a four-bar linkage including one or more pairs of first and second linkages 46, 48, with one end of each linkage 46, 48 being pivotably coupled to the frame 42 and the opposed end of each linkage 46, 48 being pivotably coupled to the toolbar 30 (e.g., via the associated mounting bracket(s) 32). However, it should be appreciated that, in alternative embodiments, the frame 42 of the row unit 40 may be coupled to the toolbar 30 in any other suitable manner. Additionally, the row unit 40 may include one or more downforce actuators 50 provided in operative association with the linkage assembly 44 for applying a downforce to the row unit 40. In one embodiment, the downforce actuators 50 may be passive actuators, such as air shocks or springs. Alternatively, the downforce actuators 50 may be actively controlled actuators, such as pneumatic or hydraulic cylinders.

Moreover, as shown in FIG. 2, the row unit 40 may include a plurality of ground-engaging tools coupled to and/or supported by the frame 42. For instance, in several embodiments, the row unit 40 may include a row cleaner assembly or “row cleaner” 52 positioned at the forward end of the row unit 40 relative to the forward direction of travel 12. In general, the row cleaner 52 may be configured to break up and/or sweep away residue, dirt clods, and/or the like from the travel path of the various components positioned downstream or aft of the row cleaner 52. In one embodiment, the row cleaner 52 may include a pair of row cleaner discs 54 (only one of which is shown in FIG. 2), with each disc 54 being pivotably coupled to the main frame via a respective row cleaner arm 56. As is generally understood, the row cleaner discs 54 may be toothed or spiked, such as by including a plurality of fingers or teeth extending radially outwardly from a central disc hub. As such, the discs 54 may be configured to roll relative to the soil as the implement 10 is moved across the field such that the teeth break up and/or sweep away residue and dirt clods. Additionally, as shown in FIG. 2, the row unit 40 may also include one or more row cleaner actuators 58 provided in association with the row cleaner 52. For instance, in the illustrated embodiment, the row unit 40 includes a pair of row cleaner actuators 58 (only one of which is shown in FIG. 2) configured to provide a downward biasing force against the row cleaner 52, with each row cleaner actuator 58 being coupled between the main frame 42 and a respective row cleaner arm 56. In one embodiment, the row cleaner actuators 58 may be passive actuators, such as air shocks or springs. Alternatively, the row cleaner actuators 58 may be actively controlled actuators, such as pneumatic or hydraulic cylinders.

Moreover, as shown in FIG. 2, the row unit 40 may also include a center coulter 60 positioned immediately aft of the row cleaner 52 relative to the forward direction of travel 12 of the implement 10. The center coulter 60 may generally be aligned with a longitudinal centerline of the row unit 40 such that the coulter 60 is positioned in the center of the row unit 40 relative to the lateral direction L of the implement 10 (i.e., the direction into and out of the page in FIG. 2). In one embodiment, the center coulter 60 may include a central hub 62 coupled to the main frame 42 for rotation relative thereto and a peripheral blade 64 extending radially outwardly from the hub 62 around its outer perimeter. The center coulter 60 may generally be configured to cut a slot or slit within the field along the center of the “row” being processed or formed by the row unit 40. Additionally, the center coulter 60 may also function together with the row cleaner 52 to ensure that residue and other trash is swept or moved laterally away from the travel path of further downstream components of the row unit 40. For instance, in one embodiment, as the row cleaner discs 54 rotate relative to the ground, the discs 54 may be configured to trap residue against the surface of the field. The blade 64 of center coulter 60 may then slice or cut through the trapped residue extending between the pair of row cleaner discs 54, thereby allowing the cut residue to be swept away from the longitudinal centerline of the row unit 40 via the action of the row cleaner discs 54.

Referring still to FIG. 2, in several embodiments, the row unit 40 may include a centralized shank 66 mounted to the main frame 42 at a location aft of the central hub 62 relative to the forward direction of travel 12 of the implement 10. In one embodiment, the shank 66 may generally be aligned with the center coulter 60 along the longitudinal centerline of the row unit 40 (i.e., aligned with the center coulter 60 in the longitudinal direction of the implement 10). The shank 66 may be configured to break out the soil along the lateral width of the row being formed by the row unit 40 at a location aft of the center coulter 60. For example, the shank 66 may be aligned with the blade 64 of the center coulter 60 such that the shank 66 travels through and breaks open the slit or slot cut into the soil via the center coulter 60. As shown in FIG. 2, the row unit 40 may also include one or more shank actuators 68 provided in association with the shank 66 for providing a downward biasing force thereto. For instance, in the illustrated embodiment, the row unit 40 includes a pair of shank actuators 68, with each shank actuator 68 being coupled between the main frame 42 and the shank 66. In one embodiment, the shank actuators 68 may be passive actuators, such as air shocks or springs. Alternatively, the shank actuators 68 may be actively controlled actuators, such as pneumatic or hydraulic cylinders. In alternative embodiments, the shank 66 may be replaced with a different ground-engaging tool, such as centralized knife positioned immediately aft of the center coulter 60.

Additionally, in several embodiments, the row unit 40 may include a forward or first pair of side coulter discs 70 (only one of which is shown in FIG. 2) positioned immediately aft of the center coulter 60 relative to the forward direction of travel 12, with each first side coulter disc 70 being disposed along either side of the shank 66 such that the discs 70 are spaced apart from the shank 66 in the lateral direction L of the implement 10. In one embodiment, each first side coulter disc 70 is pivotably coupled to the main frame 42 via a first side coulter mount assembly 72. For instance, as shown in FIG. 2, the side coulter arm assembly 72 includes a mounting arm 74 and a support arm 76, with the mounting arm 74 being pivotably coupled to the main frame 42 at one end and being coupled to the support arm 76 at the other end. The support arm 76 may, in turn, be coupled between the mounting arm 74 and its respective first side coulter disc 70 in a manner that allows the coulter disc 70 to rotate relative to the support arm 76 as the row unit 40 is being moved across the field. As shown in FIG. 2, the row unit 40 may also include one or more side coulter actuators 78 provided in association with the side coulters 78 for applying a downward biasing force thereto. For instance, in the illustrated embodiment, the row unit 40 includes a pair of side coulter actuators 78 (only one of which is shown in FIG. 2), with each side coulter actuator 78 being coupled between the main frame 42 and a respective coulter arm assembly 72. In one embodiment, the side coulter actuators 78 may be passive actuators, such as air shocks or springs. Alternatively, the side coulter actuators 78 may be actively controlled actuators, such as pneumatic or hydraulic cylinders.

In several embodiments, the side coulter discs 70 may function together with the central shank 66 to break out the soil along the width of the strip being worked or formed by the row unit 40. For instance, the side coulter discs 70 may be configured to “score” the soil to provide a pre-fracture at the desired width of the strip being formed. As an example, the side coulter discs 70 may be configured to run at a relatively shallow depth (e.g., 1-2 inches) to create scores or fracture lines” within the soil along the lateral edges of the row being formed. The shank 66 may, in turn, be configured to break out the hard soil across the lateral width extending between the fracture lines created by the side coulter discs 70.

Moreover, in several embodiments, the row unit 40 may include an aft frame assembly 80 coupled to the main frame 42 for supporting additional ground-engaging tools of the row unit 40. As shown in FIG. 2, the aft frame assembly 80 may include a pair of aft frame members 82 (only one of which is shown in FIG. 2) extending between a forward end 82A and an aft end 82B, with the forward end 82A of each frame member 82 being pivotably coupled to the main frame 42 at a forward pivot point 44. Each frame member 82 extends rearwardly from the pivot point 44 relative to the forward direction of travel 12 to its aft end 82B positioned adjacent to the aft end of the row unit 40. Additionally, in one embodiment, the row unit 40 may include one or more aft frame actuators 84 provided in association with the aft frame assembly 80 for providing a downward biasing force to the frame assembly 80 (and any ground-engaging tools supported thereby). For instance, in the illustrated embodiment, the row unit 40 includes a pair of aft frame actuators 84 (only one of which is shown in FIG. 2), with each aft frame actuator 84 being coupled between the main frame 42 and a respective aft frame member 82 of the aft frame assembly 80. In one embodiment, the aft frame actuators 84 may be passive actuators, such as air shocks or springs. Alternatively, the aft frame actuators 84 may be actively controlled actuators, such as pneumatic or hydraulic cylinders.

As shown in FIG. 2, in several embodiments, the aft frame assembly 80 may be configured to support an aft or second pair of side coulter discs 86 positioned aft or rearward of the forward or first pair of side coulter discs 70 (and aft of the shank 66) relative to the forward direction of travel 12, with each second side coulter disc 86 being disposed along either side of the longitudinal centerline of the row unit 40 such that the discs 86 are spaced apart from the centerline in the lateral direction L of the implement 10. In one embodiment, the second side coulter discs 86 may be configured to catch or block the soil coming off of the first side coulter discs 70 and shank 66 and redirect such soil back towards the center of the row being formed. As a result of redirecting the thrown soil back towards the center of the row, the aft or second side coulter discs 86 may function as “berm builders” to create a berm of soil along the centerline of the row unit 40. In such instance, the second side coulter discs 86 may be set to run at a relatively shallow depth (e.g., 1 inch or less) so that the coulter discs 86 can catch the soil without effectively tilling the soil. Alternatively, the second side coulter discs 86 may be set at a less shallow depth to allow the coulter discs 86 to perform shallow tillage (e.g., to widen the strip of worked soil beyond what the first side coulter discs 70 achieved) while still performing the function of directing soil into the right lateral shape to build a proper berm across the width of the row. In one embodiment, each second side coulter disc 86 is coupled to the aft frame assembly 80 via a second side coulter mount assembly 88. In one embodiment, the side coulter mount assembly 88 may be configured to allow the positioning of the second side coulter discs 86 to be adjusted relative to the other tools of the row unit 40, thereby allowing the coulter discs 86 to be set properly for performing their soil-catching function.

Moreover, as shown in FIG. 2, the row unit 40 may also include a finishing tool positioned at the aft end of the row unit 40. Specifically, in the illustrated embodiment, the row unit 40 includes a strip conditioner 90 coupled to the aft end 82B of the aft frame assembly 80. In general, the strip conditioner 90 may have any suitable configuration that allows it to perform its function as a finishing tool. In one embodiment, the strip conditioner 90 may be configured as a spider conditioner that functions to reduce the size of soil clods across the width of the row being formed. In other embodiments, a conditioning reel or basket may be used as the finishing tool.

It should be appreciated that the configuration of the row unit 40 described above and shown in FIG. 2 is provided only to place the present subject matter in an exemplary field of use. Thus, it should be appreciated that the present subject matter may be readily adaptable to any manner of row unit configuration. Moreover, it should be appreciated that, in some embodiments, the computing system 150 (FIG. 1) may be configured to control the row unit actuator(s) 50, 58, 68, 78, 84.

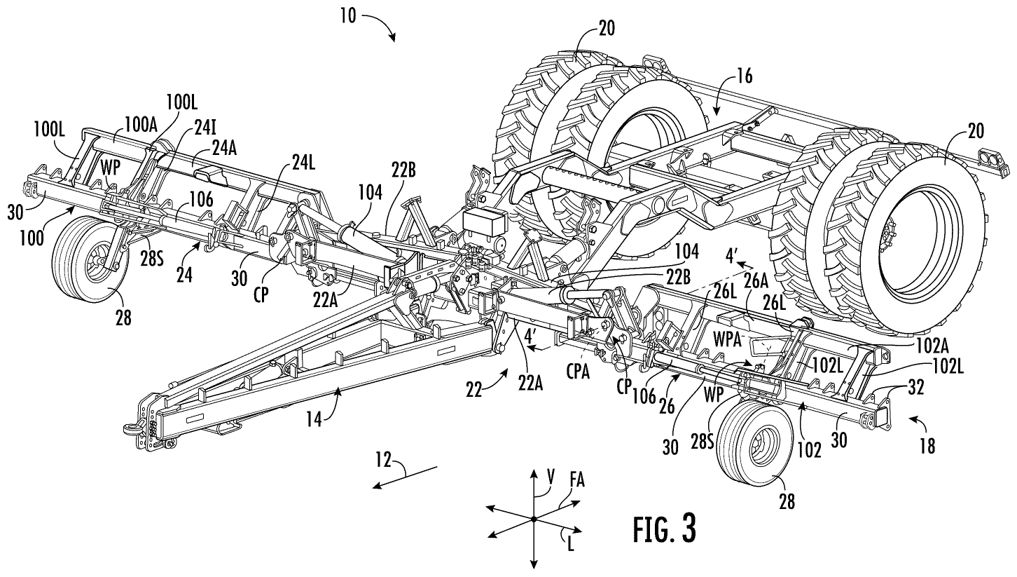

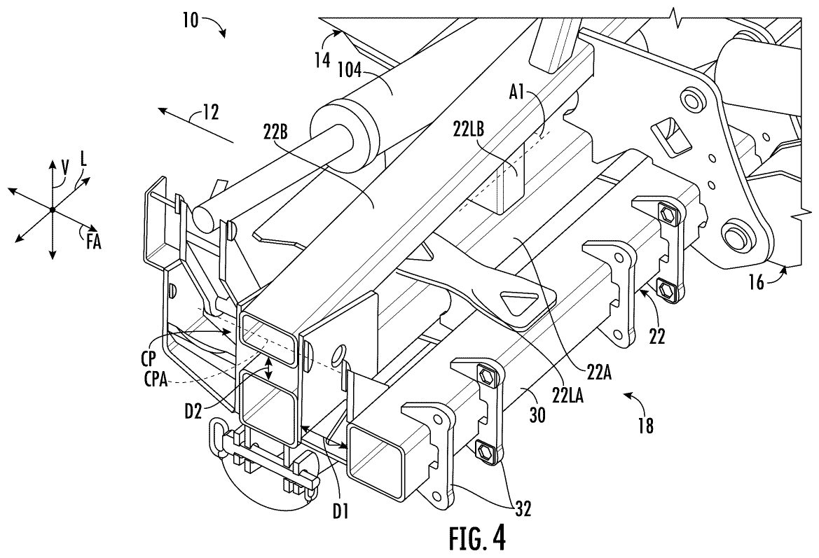

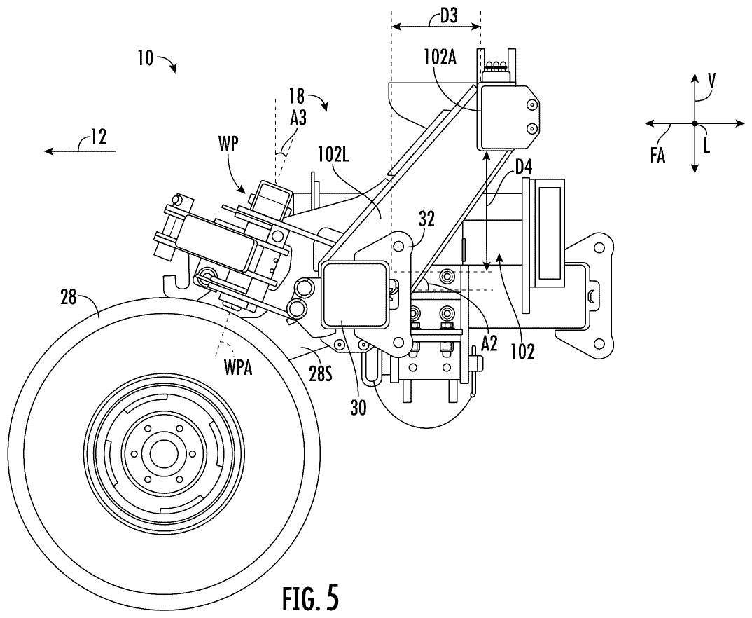

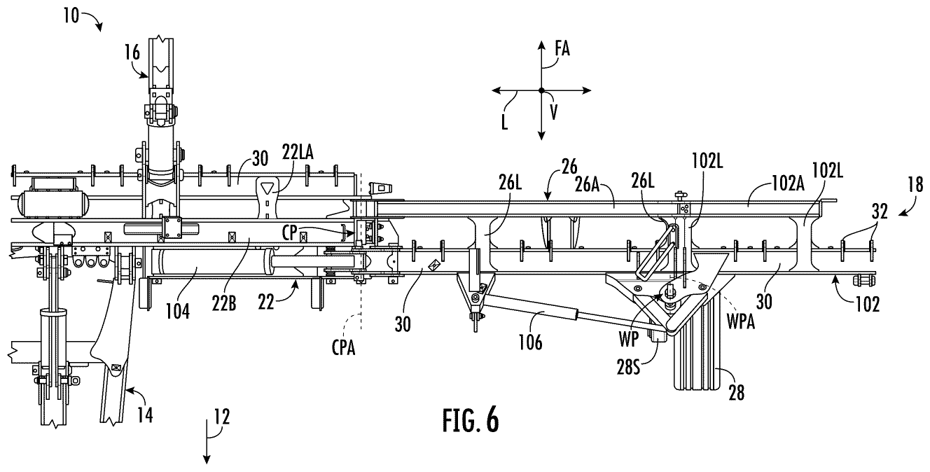

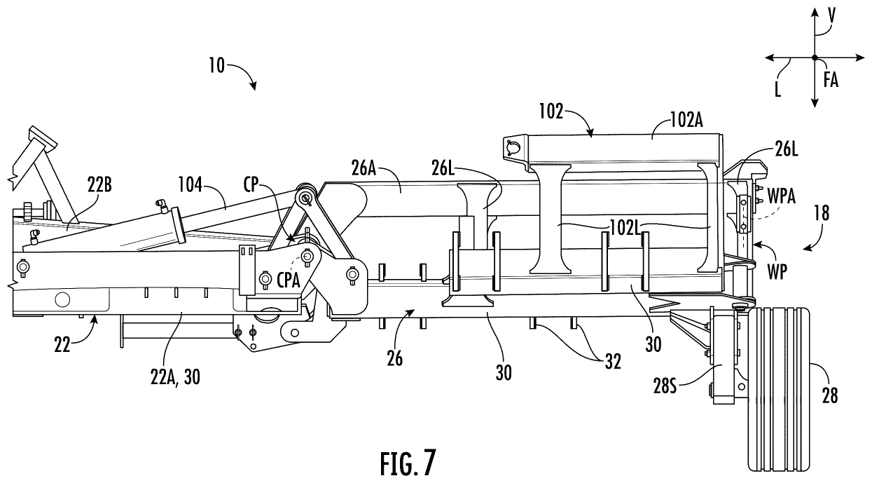

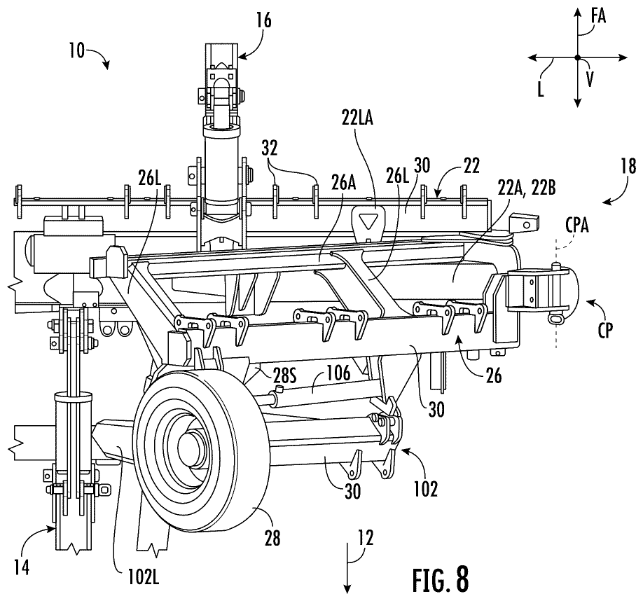

Referring now to FIGS. 3-8, various views of further example aspects of the agricultural implement 10 shown in FIG. 1 are illustrated in accordance with aspects of the present subject matter. For instance, FIG. 3 illustrates another perspective view of the agricultural implement 10 with the row units removed for purposes of illustration, and particularly illustrating additional wing toolbar sections attached to the agricultural implement 10. Further, FIG. 4 illustrates a section view of the agricultural implement 10 shown in FIG. 3, taken with reference to section line 4-4′ in FIG. 3. Moreover, FIG. 5 illustrates a partial, side view of the agricultural implement 10 shown in FIGS. 3-4, particularly illustrating one of the wing toolbar sections. FIG. 6 illustrates a partial, top-down view of the agricultural implement 10 shown in FIGS. 3-5, particularly illustrating the implement in a working position. FIG. 7 illustrates a partial, front view of the agricultural implement 10 shown in FIGS. 3-6, particularly illustrating the implement in a narrow-working position. Additionally, FIG. 8 illustrates a illustrates a partial, top-down view of the agricultural implement 10 shown in FIGS. 3-7, particularly illustrating the implement in a transport position.

The toolbar assembly 18 in FIGS. 3-8 is substantially the same as the toolbar assembly 18 shown in FIG. 1, except that it additionally includes additional wing tool bar sections. For instance, the toolbar assembly 18 additionally includes a first outer-wing toolbar section 100 (FIG. 3) coupled to a lateral end of the first wing toolbar section 24 (also referred to as “first inner-wing toolbar section 24”), opposite from the central toolbar section 22. Similarly, the toolbar assembly 18 includes a second outer-wing toolbar section 102 (FIGS. 3 and 5-8) coupled to a lateral end of the second wing toolbar section 26 (also referred to as “second inner-wing toolbar section 26”), opposite from the central toolbar section 22.

In general, the central toolbar section 22 needs to be stronger than the wing toolbar sections 24, 26, 100, 102 because the central toolbar section 22 has to support the additional load from the wing toolbar sections 24, 26, 100, 102 in addition to the chassis assembly 16. As such, the outer-wing toolbar sections 100, 102 and the inner-wing toolbar sections 24, 26 have a similar structural configuration, which differs from the central toolbar section 22. For instance, the wing toolbar sections 24, 26, 100, 102 may each be formed of two main structural members, whereas the central toolbar section 22 is formed of three main structural members.

For example, as shown in FIG. 4, the three main structural members of the central toolbar section 22 includes the central toolbar 30, a first central frame member 22A, and a second central frame member 22B coupled together to form a central truss structure. The central toolbar 30 and the first central frame member 22A each extends substantially parallel to and along the lateral direction L. The central toolbar 30 and the first central frame member 22A are spaced apart along the fore-aft direction FA by a distance D1. For instance, in one embodiment, the first central frame member 22A is spaced forward of the central toolbar 30 in the fore-aft direction, relative to the direction of travel 12, by the distance D1. In some embodiments, the central toolbar 30 and the first central frame member 22A are coupled together by at least one truss brace 22LA. The truss brace(s) 22LA extends at least partially along the fore-aft direction FA. In some instances, the truss brace(s) 22LA extend parallel to and along the fore-aft direction FA. As such, the first central frame member 22A provides additional support for the central toolbar 30 against loads in the fore-aft direction FA. In some instances, the first central frame member 22A and the central toolbar 30 have the same cross-sectional area in a plane defined parallel to the vertical and fore-aft directions V, FA, such that the first central frame member 22A essentially doubles resistance of the central toolbar 30 against loads in the fore-aft direction FA.

Similarly, the central toolbar 30 and the second central frame member 22B are spaced apart along the fore-aft direction FA and at least partially in the vertical direction V. For instance, in some embodiments, the second central frame member 22B may generally extend along the lateral direction L and be spaced forward of the central toolbar 30 along the fore-aft direction FA, relative to the direction of travel 12. For example, in one embodiment, the second central frame member 22B may be spaced forward of the central toolbar 30 along the fore-aft direction FA, relative to the direction of travel 12 (e.g., by the distance D1). Moreover, in some embodiments, the second central frame member 22B may be spaced at least partially vertically above the central toolbar 30 and the first central frame member 22A in the vertical direction V (e.g., by a distance D2). For example, the second central frame member 22B may extend in a plane parallel to both the lateral direction L and the vertical direction V, where the second central frame member 22B may extend at an angle A1 relative to the lateral direction L and thus, also at an angle relative to the central toolbar 30 and the first central frame member 22A. In some instances, the angle A1 may be a non-zero angle relative to the lateral direction L, such that the distance D2 between the second central frame member 22B and the central toolbar 30 and/or the first central frame member 22A in the vertical direction V decreases (e.g., linearly) from a lateral center of the central toolbar section 22 to a lateral end of the central toolbar section 22. The first central frame member 22A and the second central frame member 22B may be directly coupled together by one or more truss braces 22LB. The truss brace(s) 22LB extends at least partially along the vertical direction V. In some instances, the truss brace(s) 22LB extend parallel to and along the vertical direction V. As such, the first central frame member 22A provides additional support for the central toolbar 30 against loads in the vertical direction V.

In some instances, the cross-sectional area of the second central frame member 22B in a plane defined parallel to the vertical and fore-aft directions V, FA may be less than the cross-sectional areas of the central toolbar 30 and/or the first central frame member 22A. For instance, it should be appreciated that, when the angle A1 is non-zero, the second central frame member 22B may have more resistance against loads in the vertical direction V1 along its length, which allows for a reduced cross-sectional area. Particularly, a height of the second central frame member 22B along the vertical direction V may be reduced compared to a height of the first central frame member 22A and central toolbar 30 along the vertical direction V.

The two main structural members of the wing toolbar sections 24, 26, 100, 102 include a respective toolbar and a wing frame member. For instance, as best shown in FIG. 5, the wing toolbar section 102 includes a respective toolbar 30 and a wing frame member 102A coupled together in an offset configuration to form a wing truss structure. More particularly, each of the wing toolbar 30 and the wing frame member 102A extends substantially parallel to and along the lateral direction L. The wing toolbar 30 and the wing frame member 102A are spaced apart along the fore-aft direction FA by a distance D3. For instance, in one embodiment, the wing frame member 102A is spaced forward of the wing toolbar 30 in the fore-aft direction, relative to the direction of travel 12, by the distance D3. Moreover, wing toolbar 30 and the wing frame member 102A are spaced apart along the vertical direction V by a distance D4. For instance, in one embodiment, the wing frame member 102A is spaced above the wing frame member 102A along the vertical direction V by the distance D4. In some embodiments, the wing toolbar 30 and the wing frame member 102A are coupled together by at least one truss brace 102L. The truss brace(s) 102L extends at least partially along the fore-aft direction FA and at least partially along the vertical direction V, such as at an angle A2 relative to the fore-aft direction FA. As such, the wing frame member 102A provides additional support for the wing toolbar 30 against loads in the fore-aft direction FA and the vertical direction V.

In some instances, the wing frame member 102A and the wing toolbar 30 of the outer-wing toolbar section 102 have the same cross-sectional area in a plane defined parallel to the vertical and fore-aft directions V, FA. However, in one embodiment, the cross-sectional area of the wing toolbar 30 of the outer-wing toolbar section 102 is larger than the cross-sectional area of the wing frame member 102A. For example, a width of the wing frame member 102A along the fore-aft direction FA may be smaller than a width of the wing toolbar 30 along the fore-aft direction FA, while a height of the wing frame member 102A along the vertical direction V may be the same as a height of the wing toolbar 30 along the vertical direction V. Moreover, the truss brace(s) 102L may taper along the fore-aft direction FA from the wing toolbar 30 towards the wing frame member 102A.

It should be appreciated that, while only the second outer-wing toolbar section 102 is discussed in detail, the second inner-wing toolbar section 26 includes substantially the same, or the same, side profile as the second outer-wing toolbar section 102, moreover, the first inner-wing toolbar section 24 and the first outer-wing toolbar section 100 are substantially the same, or the same as, the wing toolbar section 26 and the second outer-wing toolbar section 102 respectively mirrored about the fore-aft direction FA. For instance, as shown in FIGS. 3 and 6, the second wing toolbar section 26 includes the respective inner-wing toolbar 30 and a wing frame member 26A coupled together by one or more truss braces 26L to form a respective wing frame truss member with substantially the same side profile as the outer-wing toolbar section 102. Similarly, as shown in FIG. 3, the first wing toolbar section 24 includes the respective inner-wing toolbar 30 and a wing frame member 24A coupled together by one or more truss braces 24L to for a respective wing frame truss member with substantially the same side profile as the second wing toolbar section 26 mirrored about the fore-aft direction FA. Additionally, as shown in FIG. 3, the outer-wing toolbar section 100 similarly includes the respective outer-wing toolbar 30 and a wing frame member 100A coupled together by one or more truss braces 100L to form a respective wing frame truss member with substantially the same side profile as the first wing toolbar section 24, and substantially the same side profile as the second outer-wing toolbar 102 mirrored about the fore-aft direction FA.

In general, each outer-wing toolbar section 100, 102 is pivotably coupled to the respective inner-wing toolbar section 24, 26 such that it is pivotable relative to the respective inner-wing toolbar section 24, 26 between a working position (FIGS. 3, 5, and 6) and a transport position (FIG. 7), such as by a respective outer-wing actuator 106. Similarly, each inner-wing toolbar section 24, 26 is pivotably coupled to the respective lateral end of the central toolbar section 22 such that it is movable between a working position (FIGS. 3 and 6-7) and a transport position (FIG. 8), such as by a respective inner-wing actuator 104. In some instances, the outer-wing toolbar sections 100, 102 may be shorter than the inner-wing toolbar sections 24, 26 in the lateral direction L for folding into the transport position.

As shown in FIGS. 3 and 5-7, the outer-wing toolbar section 102 is pivotably coupled by a wing pivot joint WP to the inner-wing toolbar section 26 such that the outer-wing toolbar section 102 is pivotable relative to the inner-wing toolbar section 26 about a wing pivot axis WPA between a working position (FIGS. 3, 5, and 6) and a transport position (FIG. 7). For instance, the wing pivot joint WP may be coupled to the front of each wing toolbar section 26, 102 in the fore-aft direction FA, and the wing pivot axis WPA at least partially extends along the vertical direction V. For example, the wing pivot axis WPA is tilted such that it extends at an angle A3 (FIG. 5) relative to the vertical direction V. More particularly, due to the configuration of the wing toolbar sections 26, 102, folding the outer-wing toolbar section 102 from the working position to the transport position relative to the inner-wing toolbar section 26 about the at least partially vertical wing pivot axis WPA such that the toolbars 30 of the wing toolbar sections 26, 102 are adjacent each other in the fore-aft direction FA and the wing frame members 26A, 102A are adjacent each other in the fore-aft direction FA provides a lower transport height than if the outer-wing toolbar section 102 was pivoted about a purely horizontal pivot axis.

In one embodiment, the angle A3 is preferably a non-zero angle selected such that the wing pivot axis WPA is tilted relative to both the vertical direction v and the fore-aft direction FA. For instance, the angle A3 may be selected such that the row units 40 mounted on the outer-wing toolbar section 102 do not interfere or contact the wheel 28 when pivoting between the working and transport positions.

More particularly, in some instances, the toolbars 30 of the first inner and outer wing toolbar sections 24, 100 extend coaxially when the inner and outer wing toolbar sections 24, 100 is in the working position, and the toolbars 30 of the second inner and outer wing toolbar sections 26, 102 similarly extend coaxially when the outer-wing toolbar section 102 is in the working position. Similarly, in some instances, the wing frame members 24A, 100A extend coaxially when the outer-wing toolbar section 100 is in the working position, and the wing frame members 26A, 102A similarly extend coaxially when the outer-wing toolbar section 102 is in the working position. Moreover, as described above, each wing support wheel 28 may be coupled to the respective inner-wing toolbar section 24, 26 (e.g., at the front of the respective inner-wing toolbar section 24, 26) such that the wheel 28 extends forward of the wing toolbar sections 24, 26, 100, 102 along the fore-aft direction when the respective wing toolbar sections 24, 26, 100, 102 are in the working position.

Each wing support wheel 28 is rotatably coupled to a respective wheel support 28S, where the wheel support 28S is fixed to the respective inner-wing toolbar section 24, 26, proximate the wing pivot joints WP. In certain embodiments, the wheel support 28S has a fixed length between the inner-wing toolbar section 26 and the wheel 28 such that the wheel 28 is at a fixed distance relative to the inner-wing toolbar section 26. In such instances, the fixed length is configured such that a lowest surface of the associated outer-wing toolbar section 102 (e.g., of the toolbar 30 of the associated outer-wing toolbar section 102) extends lower than a top of the wheel 28 along the vertical direction V when the outer-wing toolbar section 102 is in the outer working position. As such, the angle A3 may be selected such that the outer-wing toolbar section 102 does not interfere or contact the wheel 28 when pivoting between the working and transport positions. It should be appreciated that if the wheel support 28S does not have a fixed length such that the distance between the inner-wing toolbar section 26 and the wheel 28 is adjustable, the angle A3 may similarly be selected such that the outer-wing toolbar section 102 does not interfere or contact the wheel 28 when pivoting between the working and transport positions for any length, or at least a range of lengths, for the wheel support 28S.

Thus, the wing pivot axis WPA being tilted at the angle A3 allows the wheel 28 to be coupled to the inner-wing toolbar section 26, instead of the outer-wing toolbar section 100 such that the implement 10 may be operated in a narrow-operating position (FIG. 7). In the narrow-operating position, the outer-wing toolbar section(s) 100, 102 is moved into the transport position relative while the inner-wing toolbar section(s) 24, 26 is in the working position, with the respective wheel 28 still supporting the inner-wing toolbar section(s) 24, 26 relative to the field. As such, in the narrow-operating position, the row unit(s) 40 on the central toolbar section 22 and the inner-wing toolbar section(s) 24, 26 in the working position may engage a field while the row unit(s) 40 on the outer-wing toolbar section(s) 100, 102 in the transport position do not engage the field. It should be appreciated that, as the outer-wing sections 100, 102 may move independently of each other, in some instances, the narrow operating position include a first position where only one of the outer-wing toolbar sections 100, 102 is in the transport position and a second, narrower position where both of the outer-wing toolbar sections is in the transport position. As such, the working width of the implement 10 may be more flexible.

As shown in FIGS. 3 and 6-8, the inner-wing toolbar section 26 is pivotably coupled by a central pivot joint CP to the center toolbar section 22 such that the inner-wing toolbar section 26 is pivotable relative to the center toolbar section 22 about a central pivot axis CPA between a working position (FIGS. 3 and 6-7) and a transport position (FIG. 8). For instance, the central pivot axis CPA may at least partially extend along the fore-aft direction FA such that it is substantially horizontal. For example, the central pivot axis CPA may extend parallel to and along the fore-aft direction FA as a purely horizontal pivot axis. Due to the configuration of the wing toolbar sections 26, 102 and the central pivot joint CP, when both the inner and outer wing toolbar sections 24, 26, 100, 102 are in the working position, as best shown in FIG. 7, the toolbar sections 30 of the wing toolbar sections 24, 26, 100, 102 are forward of the central frame members 22A, 22B of the central toolbar section 22 along the fore-aft direction FA, while the wing frame members 24A, 26A, 100A, 102A of the wing toolbar sections 24, 26, 100, 102 are between the toolbar 30 of the central toolbar section 22 and the central frame members 22A, 22B of the central toolbar section 22 along the fore-aft direction FA. Thus, when the inner-wing toolbar section 26 is pivoted from the working position to the transport position (e.g., while the outer-wing toolbar section 102 is in the transport position) relative to the central toolbar section 22 about the central pivot axis CPA, the inner-wing toolbar section 26 may at least partially nest with the center toolbar section 22, with at least part of the wing frame member 26A of the inner-wing toolbar section 26 extending lower than the second center frame member 22B of the center toolbar section 22 along the vertical direction V, which reduces the overall transport height of the implement 10.

In some embodiments, the computing system 150 (FIG. 1) may be able to communicate with components associated with the implement 10, such as with the inner-wing actuators 104, the outer-wing actuators 106, and/or user interface(s). In such embodiments, the computing system 150 may be configured to perform a method to control the operation of the wing actuators 104, 106 to move the implement 10 between the working position, the narrow-operating position, and the transport position. For instance, the computing system 150 may receive an input (e.g., from a user interface associated with the implement 10) indicative of a request to perform a narrow-working operation with the implement 10 in a field. In response to receiving the input indicative of the request to perform the narrow-working operation, the computing system 150 may be configured to control the actuators 104, 106 of the implement 10 to move the inner-wing toolbar section(s) 24, 26 into the inner-wing working position (e.g., if the inner-wing toolbar section(s) 24, 26 are not already in the working position) and to move at least one of the outer-wing toolbar section(s) 100, 102 into the outer-wing transport position (e.g., if the outer-wing toolbar section(s) 100, 102 is not already in the outer-wing transport position). Thereafter, the implement 10 may be used to perform the narrow-working operation as the strip-till implement 10 moves across the field while the inner-wing toolbar section(s) 24, 26 is in the inner-wing working position and the outer-wing toolbar section(s) 100, 102 is in the outer-wing transport position.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A strip tillage implement, comprising:
a toolbar assembly comprising:
a central toolbar section comprising a central toolbar, a first central frame member, and a second central frame member coupled together to form a central truss structure, the first central frame member being spaced apart from the central toolbar along a fore-aft direction, the second central frame member being spaced apart from the central toolbar along the fore-aft direction and a vertical direction, the second central frame member being spaced apart from the first central frame member in the vertical direction; and
a wing toolbar section pivotably coupled to the central toolbar section such that the wing toolbar section is pivotable relative to the central toolbar section between a working position and a transport position, the wing toolbar section comprising a wing toolbar and a wing frame member coupled together to form a wing truss structure, the wing frame member being spaced apart from the wing toolbar along both the fore-aft direction and the vertical direction; and
a plurality of strip tillage row units supported on the central toolbar and the wing toolbar.

2. The strip tillage implement of claim 1, wherein the first central frame member is spaced forward of the central toolbar along the fore-aft direction, and
wherein the second central frame member is spaced forward of the central toolbar along the fore-aft direction and spaced above the first central frame member along the vertical direction.

3. The strip tillage implement of claim 2, wherein the central toolbar and the first central frame member extend parallel to and along a lateral direction.

4. The strip tillage implement of claim 1, wherein the wing frame member is spaced rearward of the wing toolbar along the fore-aft direction, and
wherein the wing frame member is spaced vertically above the wing toolbar along the vertical direction when the wing toolbar section is in the working position.

5. The strip tillage implement of claim 4, wherein the wing toolbar and the wing frame member extend substantially parallel to and along a lateral direction when the wing toolbar section is in the working position.

6. The strip tillage implement of claim 1, wherein a cross-section of the wing toolbar is larger than a cross-section of the wing frame member.

7. The strip tillage implement of claim 1, wherein the wing toolbar section is pivotably coupled to the central toolbar section about a horizontal pivot axis.

8. The strip tillage implement of claim 1, further comprising an outer-wing toolbar section pivotably coupled to the wing toolbar section such that the outer-wing toolbar section is pivotable relative to the wing toolbar section between an outer-wing working position and an outer-wing transport position, the outer-wing toolbar section comprising an outer-wing toolbar and an outer-wing frame member coupled together to form an outer-wing truss structure, the outer-wing frame member being spaced apart from the outer-wing toolbar along both the fore-aft direction and the vertical direction.

9. The strip tillage implement of claim 8, wherein the outer-wing toolbar section is pivotably coupled to the wing toolbar section about a tilted pivot joint such that the outer-wing toolbar section is pivotable relative to the wing toolbar section about a tilted pivot axis, the tilted pivot axis extending at a non-zero angle relative to both the vertical direction and the fore-aft direction.

10. The strip tillage implement of claim 9, further comprising a wheel and a wheel support, the wheel being rotatably coupled to the wheel support, the wheel support being fixed to the wing toolbar section proximate the tilted pivot joint, the wheel support having a fixed length between the wing toolbar section and the wheel such that the wheel is at a fixed distance relative to the wing toolbar section.

11. The strip tillage implement of claim 10, wherein the wheel is forward of the outer-wing toolbar section along the fore-aft direction when the outer-wing toolbar section is in the outer-wing working position, and
wherein a lowest surface of the outer-wing toolbar extends lower than a top of the wheel when the outer-wing toolbar section is in the outer-wing working position.

12. A strip tillage implement, comprising:
a toolbar assembly comprising:
a central toolbar section;
an inner-wing toolbar section pivotably coupled to the central toolbar section such that the inner-wing toolbar section is pivotable relative to the central toolbar section between an inner-wing working position and an inner-wing transport position, the inner-wing toolbar section comprising an inner-wing toolbar and an inner-wing frame member coupled together to form an inner-wing truss structure, the inner-wing frame member being spaced apart from the inner-wing toolbar along both a fore-aft direction and a vertical direction;
an outer-wing toolbar section comprising an outer-wing toolbar and an outer-wing frame member coupled together to form an outer-wing truss structure, the outer-wing frame member being spaced apart from the outer-wing toolbar along both the fore-aft direction and the vertical direction; and
a tilted pivot joint pivotably coupling the outer-wing toolbar section to the inner-wing toolbar section such that the outer-wing toolbar section is pivotable about a tilted pivot axis defined by the tilted pivot joint relative to the inner-wing toolbar section between an outer-wing working position and an outer-wing transport position, the tilted pivot axis extending at a non-zero angle relative to both the vertical direction and the fore-aft direction; and
a plurality of strip tillage row units supported on the central toolbar section, the inner-wing toolbar, and the outer-wing toolbar.

13. The strip tillage implement of claim 12, wherein the outer-wing toolbar section is pivotable about the tilted pivot axis such that the outer-wing toolbar section is forward of the inner-wing toolbar section when the outer-wing toolbar section is in the outer-wing transport position.

14. The strip tillage implement of claim 12, wherein the outer-wing toolbar section is pivotable about the tilted pivot axis such that both the inner-wing toolbar and the outer-wing toolbar extend coaxially and the inner-wing frame member and the outer-wing frame member extend coaxially when the outer-wing toolbar section is in the outer-wing working position.

15. The strip tillage implement of claim 12, further comprising a wheel and a wheel support, the wheel being rotatably coupled to the wheel support, the wheel support being fixed to the inner-wing toolbar section proximate the tilted pivot joint, the wheel support having a fixed length between the inner-wing toolbar section and the wheel such that the wheel is at a fixed distance relative to the inner-wing toolbar section.

16. The strip tillage implement of claim 15, wherein the wheel is forward of the outer-wing toolbar section along the fore-aft direction when the outer-wing toolbar section is in the outer-wing working position, and
wherein a lowest surface of the outer-wing toolbar extends lower than a top of the wheel when the outer-wing toolbar section is in the outer-wing working position.

17. The strip tillage implement of claim 12, wherein the central toolbar section comprises a central toolbar, a first central frame member, and a second central frame member coupled together to form a central truss structure, the first central frame member being spaced apart from the central toolbar along the fore-aft direction, the second central frame member being spaced apart from the central toolbar along the fore-aft direction and the vertical direction, the second central frame member being spaced apart from the first central frame member in the vertical direction.

18. The strip tillage implement of claim 17, wherein the central toolbar and the first central frame member extend parallel to and along a lateral direction.

19. The strip tillage implement of claim 12, wherein the inner-wing toolbar section is pivotably coupled to the central toolbar section about a horizontal pivot axis.

20. A method for operating a strip-till implement, the strip-till implement having a central toolbar section, an inner-wing toolbar section pivotably coupled to the central toolbar section such that the inner-wing toolbar section is pivotable between an inner-wing transport position and an inner-wing working position, and an outer-wing toolbar section pivotably coupled to the inner-wing toolbar section such that the outer-wing toolbar section is pivotable relative to the inner-wing toolbar section between an outer-wing transport position and an outer-wing working position, each of the inner-wing toolbar section and the outer-wing toolbar section having a wing toolbar and a wing frame member coupled together to form a respective wing truss structure and supporting a plurality of strip-till row units, the wing frame member being spaced apart from the wing toolbar along both a fore-aft direction and a vertical direction, the method comprising:
receiving, with a computing system, an input indicative of a request to perform a narrow-working operation with the strip-till implement in a field;
controlling, with the computing system, one or more actuators of the strip-till implement to move the inner-wing toolbar section into the inner-wing working position and to move the outer-wing toolbar section into the outer-wing transport position in response to receiving the input indicative of the request to perform the narrow-working operation; and
performing the narrow-working operation with the strip-till implement as the strip-till implement moves across the field while the inner-wing toolbar section is in the inner-wing working position and the outer-wing toolbar section is in the outer-wing transport position such that the plurality of strip-till row units on the inner-wing toolbar section engage the field without the plurality of strip-till row units on the outer-wing toolbar section engaging the field.
